(19) United States
(12) Patent Application Publication
(10) Pub. No.: US 2007/0021140 A1
(43) Pub. Date: Jan. 25, 2007

(54) Wireless power transmission systems and methods

(76) Inventors: Marion A. Keyes IV, Saint Louis, MO (US); Robert L. Yeager, Gibsonia, PA (US)

Correspondence Address: HANLEY, FLIGHT & ZIMMERMAN, LLC, 20 N. WACKER DRIVE, SUITE 4220, CHICAGO, IL, 60606, US

(21) Appl. No.: 11/187,165

(22) Filed: Jul. 22, 2005

(51) Int. Cl. H04B 7/00; H04Q 7/20

(52) U.S. Cl. 455/522

(57) ABSTRACT

Methods, apparatus, and articles of manufacture to power a device using wirelessly transmitted power are disclosed. Initially, a wireless base unit obtains a request for wireless power. The wireless base unit then determines a power requirement associated with a wireless field unit and compares the power requirement to a remaining power capacity of the wireless base unit. The wireless base unit then transmits power wirelessly to the wireless field unit based on the comparison of the power requirement to the remaining power capacity. The wirelessly transmitted power is associated with powering a field device operatively coupled to the wireless field unit.

### FIELD OF THE DISCLOSURE

The present disclosure relates generally to process control systems and, more particularly, to wireless power transmission systems and methods.

### BACKGROUND

Process control systems, like those used in chemical, petroleum or other processes, typically include one or more centralized process controllers communicatively coupled to at least one host or operator workstation and to one or more field devices via analog, digital or combined analog/digital buses. The field devices, which may be, for example, device controllers, valves, valve positioners, switches and transmitters (e.g., temperature, pressure and flow rate sensors), perform functions within the process control system such as opening or closing valves and measuring process parameters. A central process controller receives signals indicative of process measurements made by the field devices and/or other information pertaining to the field devices, uses this information to implement a control routine and then generates control signals that are sent over the buses or other communication lines to the field devices to control the operation of the process control system.

Field devices may be placed anywhere within a process control system. In some instances, field devices are placed at locations that are not ideal for installing electrical wires or cables for power and communications. For instance, environmental conditions in some process control areas may cause wiring or cabling to breakdown or malfunction. Additionally, installing casings or metal conduit to protect the cabling is typically time consuming and expensive and difficult to reconfigure (e.g., re-route) after installation.

In some cases, a large number of field devices are distributed within a relatively small process control area. Installing electrical cables or wires for a large number of field devices within a relatively small area is often complex and time consuming and can create problems such as entanglement, cross connections, and difficulty in performing upgrades, repairs or replacements. Further, supplying power and communications via cables or wires increases the complexity and difficulty of rearranging or reconfiguring a process control system.

Recent developments addressing issues associated with hardwired field devices include communicating wirelessly with field devices and powering field devices using batteries. While providing wireless communications and batteries may eliminate (or at least reduce) the need for cables or wires, batteries create additional duties such as monitoring battery levels, changing field device batteries periodically, and disposing of used batteries in a safe, legal manner.

### SUMMARY

Example methods and apparatus for transmitting power wirelessly are disclosed herein. In accordance with one example, a method of powering a device using wirelessly transmitted power involves obtaining via a wireless base unit a request for wireless power. The wireless base unit then determines a power requirement associated with a wireless field unit and compares the power requirement to a remaining power capacity of the wireless base unit. The wireless base unit then transmits power wirelessly to the wireless field unit based on the comparison of the power requirement to the remaining power capacity. The wirelessly transmitted power is associated with powering a field device operatively coupled to the wireless field unit.

In accordance with another example, a method of receiving wirelessly transmitted power involves obtaining a low-power transmission via a wireless field unit and powering a communications circuit of the wireless field unit using the low-power transmission. The wireless field unit then communicates a power request message, receives wirelessly transmitted power associated with the power request message, and powers a field device using the wirelessly transmitted power.

In accordance with another example, a method of managing wireless power transmission involves wirelesly transmitting power via a first wireless base unit to a wireless field unit based on a first power requirement and powering a field device associated with the wireless field unit using the wirelessly transmitted power. A request is then obtained from the wireless field unit to increase the wirelessly transmitted power to a second power requirement. The second power requirement is then compared to a remaining power capacity associated with the first wireless base unit. Power is then transmitted wirelessly to the wireless field unit based on the second power requirement and the comparison of the second power requirement and the remaining power capacity.

In accordance with yet another example, a system for transmitting power wirelessly includes at least one wireless field unit communicatively coupled to a field device and at least one wireless base unit communicatively coupled to the wireless field unit. The wireless field unit is configured to wirelessly transmit power to the wireless field unit and the wireless field unit is configured to receive the wirelessly transmitted power and power the field device using the wirelessly transmitted power. The wireless base unit is also configured to exchange process control data with the wireless field unit.

### BRIEF DESCRIPTION OF THE DRAWINGS

FIG. 1 is a block diagram illustrating an example process control system that uses the wireless power transmission systems and methods described herein.

FIG. 2 is an example power requirement table associated with the power requirements of a plurality of wireless field units.

FIG. 3 is a block diagram depicting a system redundancy configuration that may be used to implement the example process control system of FIG. 1 to provide fault toleration.

FIG. 4 depicts detailed block diagrams of an example wireless base unit and an example wireless field unit.

FIG. 5 is a detailed schematic of the example signal conditioner of the example wireless base unit of FIG. 4.

FIG. 6 is a detailed schematic of the example signal conditioner of the example wireless field receiver of FIG. 4.

FIGS. 7A and 7B are flowcharts illustrating an example method that may be used to implement the example wireless field receiver of FIG. 4.

FIGS. 8A-8C are flowcharts illustrating an example method that may be used to implement the example wireless base unit of FIG. 4.

FIG. 9 is a flowchart of an example method that may be used to reallocate power loads among a plurality of wireless base units.

FIG. 10 is a flowchart of an example method that may be used to redundantly transmit power and data via a plurality of frequencies from a wireless base unit to one or more wireless field units.

FIG. 11 is a block diagram of an example processor system that may be used to implement the example systems and methods described herein.

### DETAILED DESCRIPTION

Although the following discloses example systems including, among other components, software and/or firmware executed on hardware, it should be noted that such systems are merely illustrative and should not be considered as limiting. For example, it is contemplated that any or all of these hardware, software, and firmware components could be embodied exclusively in hardware, exclusively in software, or in any combination of hardware and software. Accordingly, while the following describes example systems, persons of ordinary skill in the art will readily appreciate that the examples provided are not the only way to implement such systems.

Unlike known systems that require field device power (e.g., alternating current (AC) power or direct current (DC) power) to be provided via electrical wires or cables and/or via a battery, the example systems and methods described herein may be used to implement field devices (e.g., a temperature sensor, a pressure sensor, a status (open/closed) sensor, an actuator, etc.) in a process control system that operate using wirelessly transmitted power and that communicate wirelessly within the process control system. In one example, a base unit is configured to transmit power wirelessly (e.g., using radio frequency electromagnetic waves) to wireless field units having attached field devices and to exchange process control data with the wireless field units via wireless transmissions. Wirelessly transmitting power and data to field devices provides a process plant greater flexibility to configure the physical layouts of process control systems. In the illustrated examples described below, the layout of a process control system is not limited by the locations of wired power sources or wired networks. Instead, field devices and other elements of a process control system may be located anywhere and use wireless power transmissions to receive power and wireless data communications to exchange data with other process control system devices or apparatus. Wireless power and data also enables reconfiguring the layout of process control systems relatively easier and quicker because relatively fewer cables or wires need to be moved or installed to relocate field devices.

The example wireless base unit described herein may be coupled to an electrical power source (e.g., an AC power source, a DC power source, etc.) via cables or wires and is communicatively coupled to control equipment (e.g., application stations, controllers, processor systems, servers, etc.), which may be used to manage, automate, and control a process control system. The control equipment is used to store and exchange process control data (e.g., configuration information, status information, control parameter information, etc.) with field devices. For example, a process control system server or an application station may communicate configuration information to field devices via the example wireless base unit or acquire field device status or measurement information via the example wireless base unit.

Each example wireless field unit is electrically and communicatively coupled to a respective field device. In some example implementations, the wireless field unit is integral with the field device. The example wireless field unit receives the power transmitted wirelessly by the wireless base unit, powers portions of itself using some of the wirelessly transmitted power, and substantially simultaneously supplies some of the received power to its associated field device to power the field device. In this manner, the field device is powered using a portion of the wirelessly transmitted power.

In addition, each example wireless field unit exchanges process control data with a respective field device (e.g., with a field device to which it is coupled). For example, the example wireless base unit may obtain configuration information from a control server and communicate the configuration information to corresponding wireless field units, each of which then communicates the configuration information to a respective field device. In addition, each of the wireless field units may communicate status information from a respective field device to the wireless base unit, which then communicates the status information to the control server.

The example wireless base units are configured to securely, reliably, and robustly transmit power to the wireless field units and exchange process control data with the wireless field units. For example, as described below, each wireless field unit is associated with a unique identifier (ID), a security key, or a code (e.g., a wireless field unit ID or variation thereof) that may be used to encrypt or route power and data exclusively to a particular or designated wireless field unit. The wireless base units may also transmit power and data wirelessly using spread spectrum transmission techniques that are decodable only by the particular or designated wireless field unit. In this manner, other wireless devices cannot intercept the transmitted power or data. A process plant may use the encryption techniques described below to protect its process control systems from malicious activity such as tampering or hacking, thereby reducing costs associated with repairs and maintenance of the process control systems. Also, by encrypting the wirelessly transmitted power, the process control plant utility resources (e.g., electrical energy) can be protected from being stolen or hijacked by intruders.

The example wireless base units and example wireless field units described herein are configured to use a plurality of techniques to reliably and robustly transmit power and exchange data. For example, the wireless base units may provide robust and/or failsafe power transmission by, for example, redundantly transmitting power on a plurality of frequency bands or, alternatively, by using frequency hopping transmission techniques. Also, the wireless base units may be configured to communicate with any of the wireless field units. In this manner, if a particular wireless base unit fails, one or more other wireless base units can replace the failed wireless base unit by performing the wireless power transmission and data communications previously performed by the failed wireless base unit. Further, the wireless field units may function as repeaters so that if a wireless field unit is too far away from a particular wireless base unit, that wireless base unit may transmit power to and exchange data with the wireless field unit via an intermediary wireless field unit operating as a repeater. Other redundancies associated with process control equipment (e.g., redundant processor systems, redundant application stations, redundant controllers, etc.) may also be implemented as described below to provide fault tolerant and robust operation of a process control system. A process plant can use the robust, fault tolerant, and reliable power and data transmission examples described herein to reduce the downtimes associated with equipment malfunctions and, thus, maintain profits by maintaining steady production levels.

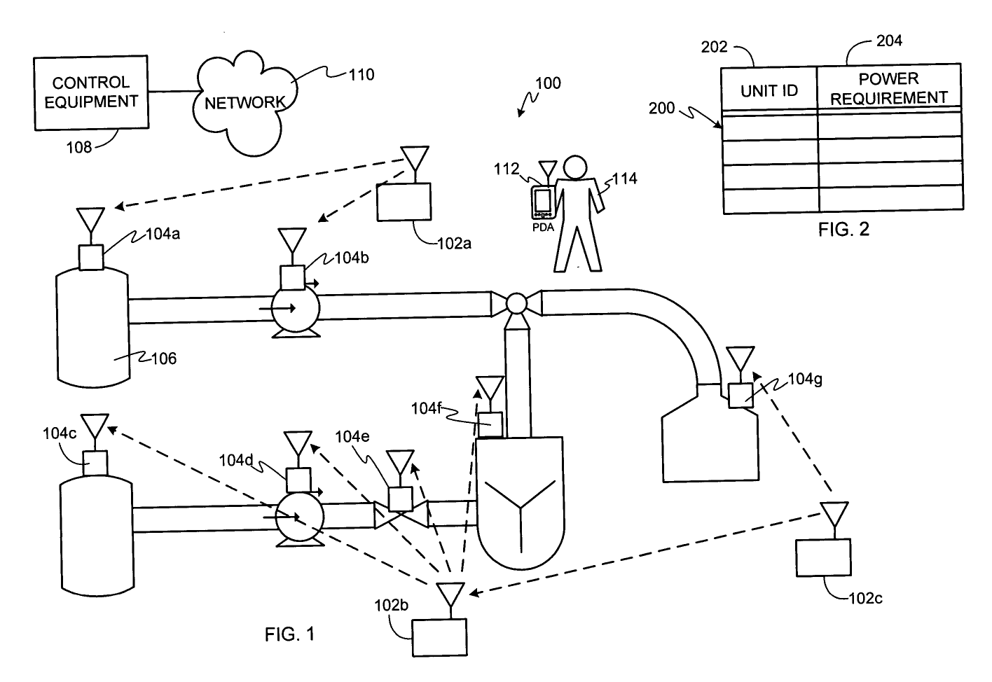

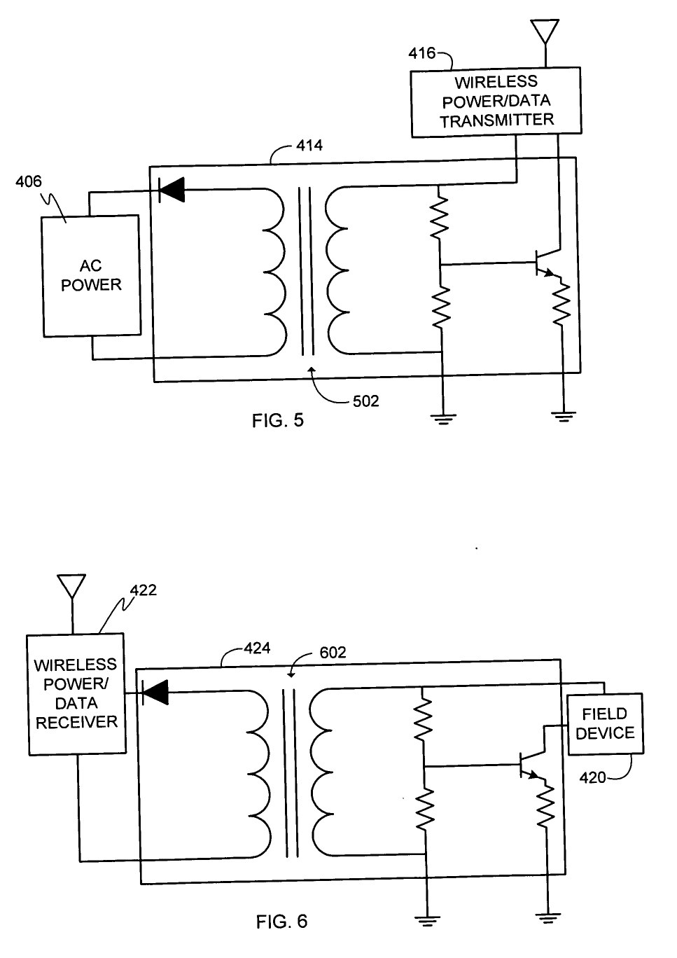

FIG. 1 is a block diagram illustrating an example process control system 100 that uses the wireless power transmission systems and methods described herein. The example process control system 100 includes a first example wireless base unit 102a, a second example wireless base unit 102b, and a third example wireless base unit 102c. The example process control system 100 also includes a plurality of wireless field units 104a-g. As indicated by dashed lines in FIG. 1, the wireless base units 102a-c are wirelessly coupled to the wireless field units 104a-g. In this manner, the wireless base units 102a-c can transmit power wirelessly to and exchange process control data with the wireless field units 104a-g. Each of the wireless field units 104a-g is electrically and communicatively coupled to a respective field device (e.g., the field device 420 of FIG. 4). Each field device is associated with the operation of a respective process element, equipment, plant area, etc. For example, the wireless field unit 104a is coupled to a field device that is associated with the operation of a holding tank 106. In this case, the field device at the holding tank 106 may be a temperature sensor, a pressure sensor, a level sensor, or any other suitable sensor or combination of sensors.

The wireless base units 102a-c and the wireless field units 104a-gmay be packaged in any suitable mechanical enclosure or housing. In an example implementation, the wireless base units 102a-c and the wireless field units 104a-gare enclosed in plastic sheeting that protects the units 102a-c and 104a-gfrom tampering and environmental elements (e.g., chemicals, water, temperature, etc.). The plastic sheeting may be painted so that the wireless base units 102a-c and the wireless field units 104a-gare visually unobtrusive (e.g., aesthetically unobtrusive, spatially unobtrusive, etc.).

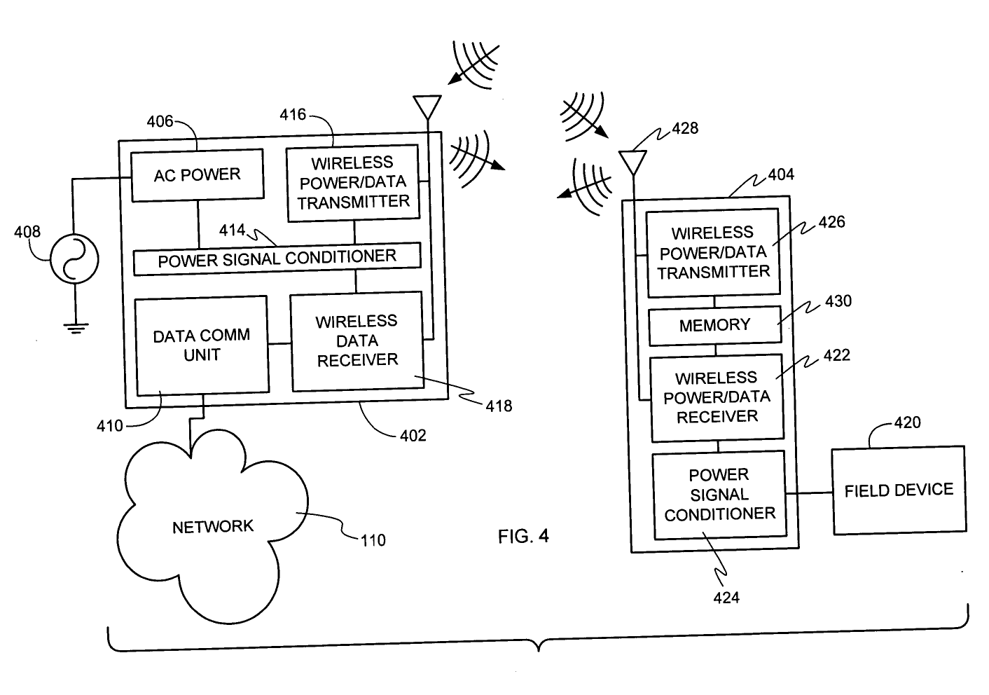

The example process control system 100 also includes control equipment 108 that is communicatively coupled to the wireless base units 102a-c via a network 110 and communicatively coupled to the wireless field units 104a-gvia the wireless base units 102a-c. The control equipment 110 may be located in one or more control rooms of a process plant. The network 110 may be implemented using any wired or wireless local area network (LAN) or wide area network (WAN) such as, for example, wired Ethernet, 802.11, Bluetooth®, the Internet, etc. In one example implementation, the network 110 may implement digital data busses 314a and 314b described below in connection with FIG. 3.

The control equipment 108 may execute process control software that manages and analyzes operations of the process control system 100. For example, the control equipment 108 may be used to store process control data and exchange process control data with the wireless base units 102a-c and the wireless field units 104a-g. Also, the control equipment 108 may manage and track the operation of the wireless base units 102a-c. For example, the control equipment 108 may determine if any of the wireless base units 120a-c has failed or is overloaded and may inform system engineers of any such problems via alerts (e.g., email messages, pages, phone calls, pop-up graphical displays, audio alarms, etc.). The control equipment 108 is described in greater detail below in connection with FIG. 3.

The wireless field units 104a-gmay also be configured to communicate with a portable computing device 112. The portable computing device 112 may be implemented using a personal digital assistant (PDA), a cell phone, a laptop, or any other suitable portable computing device. The portable computing device 112 may be configured to communicate wirelessly (e.g., using 802.11, Bluetooth®, etc.) with the wireless base units 102a-c and/or the wireless field units 104a-g and may be employed by a user 114 (e.g., a system engineer) to exchange process control data with the wireless base units 102a-c and/or the wireless field units 104a-g. In an example implementation, the portable computing device 112 may communicate with a particular wireless field unit via any combination of one or more wireless base units and wireless field units. In this case, the one or more wireless base units and wireless field units function as repeaters to exchange process control data between the portable computing device 112 and a particular one of the wireless field units 104a-g.

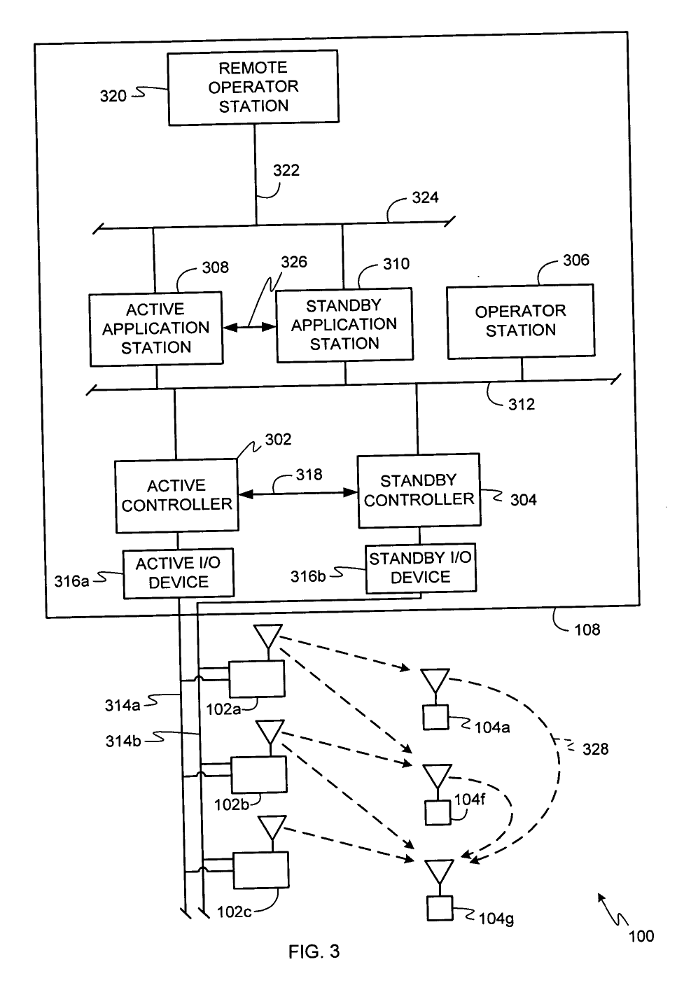

FIG. 2 is an example power requirement table 200 associated with the power requirements of a plurality of field units (e.g., the wireless field units 104a-gof FIG. 1). The example power requirement table 200 may be implemented using, for example, a look-up table or any other data structure, and may be stored in a memory of a wireless base unit (e.g., the wireless base units 102a-c of FIG. 1). Each of the wireless base units 102a-c stores a power requirement table that is substantially similar or identical to the power requirement table 200. Each of the wireless base units 102a-c uses a respective power requirement table o log or maintain a status of the ones of the wireless field units 104a-gto which that wireless base unit is transmitting power wirelessly and the amount of power that the wireless base unit is transmitting to each of the wireless field units 104a-g. In this manner, each of the wireless base units 102a-c can determine its remaining power capacity by summing the amount of power transmitted as indicated in the power requirement table 200 and subtracting the sum from its total power capacity.

The power requirement table 200 includes a unit ID column 202 for storing unique ID's respectively associated with each of the wireless field units 104a -g and a power requirement column 204 for storing the power requirements of each of the wireless field units 104a-g. For example, the wireless base unit 102b may store in the unit ID column 202 the wireless field unit ID's for each of the wireless field units 104c-f and in the power requirement column 204 the amount of power required by each of the wireless field units 104c-f to which the wireless base unit 102b transmits power wirelessly. The values stored in the power requirement column 204 indicate the amount of power that is being transmitted wirelessly to a wireless field unit by the wireless base unit in which the power requirement table 200 is stored. If the wireless base unit storing the power requirement table 200 is transmitting to a particular wireless field unit all of the power required by that wireless field unit, then the amount of power required by the wireless field unit is stored in the power requirement column 204. However, if the wireless base unit storing the power requirement table 200 is transmitting to a particular wireless field unit only a portion of the power required by that wireless field unit, then a power value corresponding to the portion of power transmitted to the wireless field unit is stored in the power requirement column 204.

FIG.3 is a block diagram depicting a system redundancy configuration that may be used to implement the example process control system 100 of FIG. 1 to provide fault tolerant operation. As shown in FIG. 3, the control equipment 108 (FIG. 1) of the process control system 100 includes an active controller 302, a standby controller 304, an operator station 306, an active application station 308, and a standby application station 310, all of which may be communicatively coupled via a bus or local area network (LAN) 312, which is commonly referred to as an application control network (ACN). The operator station 306 and the application stations 308 and 310 may be implemented using one or more workstations or any other suitable computer systems or processing units. For example, the application stations 308 and 310 could be implemented using single processor personal computers, single or multi-processor workstations, etc. In addition, the LAN 312 may be implemented using any desired communication medium and protocol. For example, the LAN 312 may be based on a hardwired or wireless Ethernet communication scheme, which is well known and, thus, is not described in greater detail herein. However, as will be readily appreciated by those having ordinary skill in the art, any other suitable communication medium and protocol could be used. Further, although a single LAN is shown, more than one LAN and appropriate communication hardware within the application stations 308 and 310 may be used to provide redundant communication paths between the application stations 308 and 310.

The controllers 302 and 304 may be coupled to the wireless base units 102a-c (FIG. 1) via respective digital data busses 314a and 314b (i.e., an active digital data bus 314a and a standby digital data bus 314b) and respective input/output (I/O) devices 316a and 316b (i.e., an active I/O device 316a and a standby I/O device 316b). In one example, the digital data busses 314a and 314b maybe implemented by the network 110 of FIG. 1. In an alternative example, the wireless base units 102a-c may be Fieldbus compliant, in which case the wireless base units 102a-c communicate via the digital data busses 314a and 314b using the well-known Fieldbus protocol. In yet another alternative example, other types of communication protocols could be used. For example, the wireless base units 102a-c could instead be Profibus or HART compliant devices that communicate via the data busses 314a and 314b using the well-known Profibus and/or HART communication protocols. Additional I/O devices (similar or identical to the I/O devices 316a and 316b) may be coupled to the controllers 302 and 304 to enable additional groups of wireless base units 102a-c, which may be Fieldbus devices, HART devices, etc., to communicate with the controllers 302 and 304.

Each of the controllers 302 and 304 may be, for example, a DeltaV™ controller sold by Fisher-Rosemount Systems, Inc. However, the controllers 302 and 304 may be implemented using any other type of controller. The controllers 302 and 304 may perform one or more process control routines associated with the process control system 100 that have been generated by a system engineer or other system operator using the operator station 306 and which have been downloaded to and instantiated in the controllers 302 and 304. Although two redundant controllers (e.g., the controllers 302 and 304) are shown in the illustrated example, the process control system 100 may include any number of redundant controllers.

The standby controller 304 functions as a backup for the active controller 302 for cases in which the active controller 302 becomes unavailable or for any reason becomes unable to perform the process control routines associate with the process control system 100. The controllers 302 and 304 are communicatively coupled via a first redundancy link 318.

The first redundancy link 318 may be a separate, dedicated (i.e., not shared) communication link between the active controller 302 and the standby controller 304. The first redundancy link 318 may be implemented using, for example, a dedicated Ethernet link (e.g., dedicated Ethernet cards in each of the controllers 302 and 304 that are coupled to each other). However, in other examples, the first redundancy link 318 could be implemented using the LAN 312 or a redundant LAN (not shown), neither of which is necessarily dedicated, that is communicatively coupled to the controllers 302 and 304. Of course, in other example implementations the first redundancy link 318 may be implemented using a universal serial bus (USB) interface, an RS-232 interface, an IEEE 1394 (FireWire™) interface, or any other suitable interface.

Generally speaking, the controllers 302 and 304 continuously, by exception, or periodically exchange information (e.g., in response to parameter value changes, application station configuration changes, etc.) via the first redundancy link 318 to establish and maintain a redundancy context. The redundancy context enables a seamless or bumpless handoff or switchover of control between the active controller 302 and the standby controller 304. For example, the redundancy context enables a control handoff or switchover from the active controller 302 to the standby controller 304 to be made in response to a hardware or software failure within the active controller 302 or in response to a directive from a system user or system operator or a client application of the process control system 100.

In any event, the controllers 302 and 304 may appear as a single node on the LAN 312 and, thus, function as a redundant pair. In particular, the standby controller 304 functions as a “hot” standby application station that, in the event the active controller 302 fails or receives a switchover directive from a user, rapidly and seamlessly assumes and continues control of applications or functions being executed by the active controller 302 without requiring time consuming initialization or other user intervention. To implement such a “hot” standby scheme, the currently active controller (e.g., the active controller 302) uses the redundancy context to communicate information such as, for example, configuration information, control parameter information, etc. via the first redundancy link 318 to its redundant partner controller (e.g., the standby controller 304). In this manner, a seamless or bumpless transfer of control or switchover from the currently active controller (e.g., the active controller 302) to its redundant partner or standby controller (e.g., the standby controller 304) can be made as long as the standby controller 304 is ready and able to assume control.

To ensure that the standby controller 304 is ready and able to assume control of applications, virtual control functions, communication functions, etc. currently being performed by the active controller 302, the redundancy context determines whether the standby controller 304 has access to the physical resources (e.g., the LAN 312, other external data sources, etc.), has the required programming information (e.g., configuration and connection information), and whether the required quality of service (e.g., processor speed, memory requirements, etc.) is available. The redundancy context may also determine whether the standby controller 304 has access to the wireless base units 102a-c via the standby digital data bus 314b. Additionally, the redundancy context is maintained to ensure that the standby controller 304 is always ready to assume control. This redundancy context maintenance is carried out by conveying status information, configuration information or any other information, which is needed to maintain operational synchronization, between the redundant controllers 302 and 304.

In some examples, the controllers 302 and 304 may be configured so that in the event the active controller 302 fails and subsequently recovers to a healthy state or is repaired or replaced (and appropriately configured), the active controller 302 regains control from the standby controller 304 and the standby controller 304 resumes its status as a hot standby station. However, if desired, the standby controller 304 may be configured to prevent a recovering application station from regaining control without system user approval or some other type of user intervention.

As depicted in FIG. 1, the process control system 100 may also include a remote operator station 320 that is communicatively coupled via a communication link 322 and a LAN 324 to the application stations 308 and 310. The remote operator station 320 may be geographically remotely located, in which case the communication link 322 is preferably, but not necessarily, a wireless communication link, an internet-based or other switched packet-based communication network, telephone lines (e.g., digital subscriber lines), or any combination thereof. Although two operator stations (e.g., the operator station 306 and the remote operator station 320) are shown in the illustrated example, the process control system 100 may be communicatively coupled to any number of operator stations.

As depicted in the example of FIG. 1, the active application station 308 and the standby application station 310 are communicatively coupled via the LAN 312 and via a second redundancy link 326. The second redundancy link 326 is substantially similar or identical to the first redundancy link 318 and is used to maintain operational synchronization between the active and standby application stations 308 and 310. For example, the application stations 308 and 310 may maintain operational synchronization via the second redundancy link 326 and the standby application station 310 may function as a backup for the active application station 308 in a manner that is substantially similar or identical to that describe above in connection with the first redundancy link 318 and the controllers 302 and 304.

The active application station 308 is ordinarily responsible for carrying out (i.e., executing) virtual control functions, campaign management applications, maintenance management applications, diagnostic applications, and/or any other desired function or applications that may pertain to management and/or monitoring of process control activities, enterprise optimization activities, etc. needed within the process control system 100. The standby application station 310 is configured in an identical manner to the active application station 308 and, thus, includes a copy of each function and application that is needed for execution within the active application station 308. In addition, the standby application station 310 includes hardware and/or access to resources that are identical or at least functionally equivalent to the resources available to the active application station 308. Still further, the standby application station 310 tracks the operation of the active application station 308 (e.g., the current parameter values used by applications being executed within the active application station 308) via the second redundancy link 326. Although two application stations (e.g., the application stations 308 and 310) are shown in the illustrated example, the process control system 100 may include any number of application stations.

The wireless base units 102a-c and the wireless field units 104a-g are configured to operate in a redundant manner to further provide fault tolerant and robust operation of the process control system 100. In the illustrated example of FIG. 3, each of the wireless base units 102a-c can transmit power to and exchange information with any of the wireless field units 104a, 104f, and 104g. In this manner, if any of the wireless base units 102a-c fails or becomes unavailable for any reason (e.g., power loss, tampering, hacking, etc.), the operations (e.g., power transmission, data communications, etc.) previously performed by the unavailable wireless base unit can be taken over or performed by another one or more of the wireless base units 102a-c. For example, each of the wireless base units 102a-c may maintain a wired or wireless redundancy link (not shown) that is substantially similar or identical to the redundancy links 318 and 326 described above. Each of the wireless base units 102a-c may maintain operational synchronization with one or more of the other wireless base units 102a-c and function as a backup for one or more of the other wireless base units 102a-c in a manner that is substantially similar or identical to that described above in connection with the first redundancy link 318 and the controllers 302 and 304.

Each of the wireless field units 104a-g is configured to operate as a repeater to retransmit power and information received from one of the wireless base units 102a-c to another one of the wireless field units 104a-g. In this manner, if one of the wireless field units 104a-g is too far away from a nearest one of the wireless base units 102a-c or if an RF-impermeable or RF-attenuating object (e.g., a wall, a holding vessel, a mixer, etc.) is disposed or located between one of the wireless field units 104a-g and a nearest one of the wireless base units 102a-c, the nearest one of the wireless base units 102a-c may transmit power to and exchange data with the too-distant or obstructed one of the wireless field units 104a-g via another one of the wireless field units 104a-g. In the illustrated example of FIG. 3, the wireless base unit 102a may transmit power and data to the wireless field unit 104g via the wireless field unit 104a as depicted by dashed line 328.

FIG. 4 depicts an example wireless base unit 402 and an example wireless field unit 404. The example wireless base unit 402 may be used to implement the example wireless base units 102a-c of FIG. 1, and the example wireless field unit 404 may be used to implement the example wireless field units 104a-g of FIG. 1. As shown in FIG. 4, the example wireless base unit 402 includes an AC power interface 406 that is configured to be electrically coupled to an AC power source 408 to obtain electrical power. The example wireless base unit 402 also includes a data communication unit 410 that is communicatively coupled to the network 110 and configured to exchange process control data with a control server (e.g., the control equipment 108 of FIG. 1) via the network 110. The data communication unit 410 may be implemented using any type of wired or wireless communication protocol including, for example, wired Ethernet, 802.11, Bluetooth®, Fieldbus, Profibus, HART, etc.

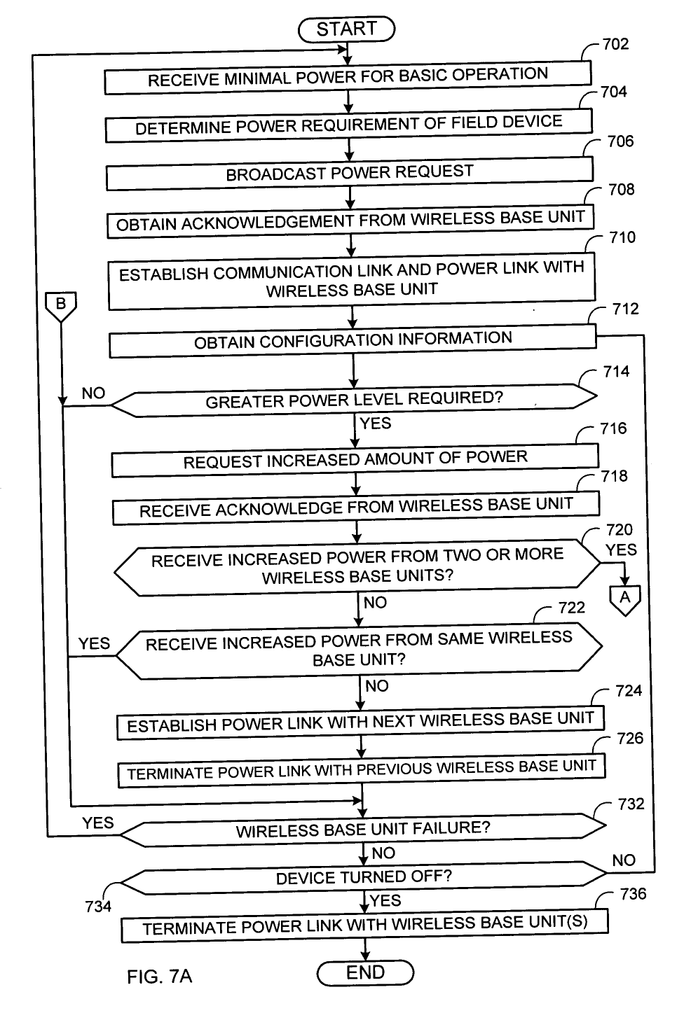

The example wireless base unit 402 also includes a power signal conditioner 414 that is configured to obtain AC power from the AC power interface 406 and condition the power. For example, the power signal conditioner 414 may regulate the AC power and protect the wireless base unit 402 against power surges, current spikes, electrostatic discharges, etc. The power signal conditioner 414 is described in greater detail below in connection with FIG. 5.

The example wireless base unit 402 includes a wireless power and data transmitter 416 to transmit power and data wirelessly to wireless field units (e.g., the wireless field unit 404). The wireless power and data transmitter 416 is also configured to transmit data to the portable computing device 112 (FIG. 1). The wireless power and data transmitter 416 is configured to use radio frequency (RF) signals to transmit power via wireless power links and simultaneously transmit data via wireless data links (i.e., wireless communication links). The wireless power and data transmitter 416 may be configured to multiplex the power and the data and transmit both using the same transmission channel or frequency signal. In this case, the wireless power link and the wireless data link are multiplexed or transmitted substantially simultaneously via the same transmission channel or frequency signal. For example, the wireless power and data transmitter 416 may be configured to transmit data packets embedded or multiplexed within a wireless power transmission. Alternatively, the wireless power and data transmitter 416 may be configured to transmit data to the wireless field unit 404 via a data transmission channel and transmit power to the wireless field unit 404 via a power transmission channel separate from the data transmission channel (e.g., via a different frequency than that used by the data transmission channel). In any case, the wireless power and data transmitter 416 may embed a wireless field unit ID code in the wirelessly transmitted power and in the data using any technique well known in the art for analog signals (e.g., frequency shift keying (FSK), phase shift keying (PSK), frequency modulation, amplitude modulation, etc.) and/or digital signals (e.g., bit insertion, data packet bit fields, etc.) to indicate to the wireless field unit to which the power and each data packet corresponds.

The wireless power and data transmitter 416 may be configured to transmit each of a plurality of different power levels via a respective one of a plurality of different frequency signals. For example, the wireless power and data transmitter 416 may transmit a low-power wireless transmission (e.g., a low-level power wireless transmission or a wireless transmission having a minimal power level) on a particular frequency to initially power up basic components of a wireless field unit for initial communications. The particular frequency at which the wireless power and data transmitter 416 transmits the low-level minimum power (i.e., the low-power wireless transmission) may be a fixed, pre-selected frequency signal that any of the wireless field units can access. In an example implementation, the low-power wireless transmission is not encoded for any particular wireless field unit so that any wireless field unit can receive and use the low-power wireless transmission. In this manner, a wireless field unit may establish a wireless power link with the wireless base unit 402 prior to receiving a greater amount of power from the wireless base unit 402 required for normal operation of an attached device (e.g., the field device 420 described below). The wireless power link may be established using a different frequency signal than that used to transmit the low-level minimum power.

In the example process control system 100 of FIG. 1, all of the wireless base units 102a-c may transmit the low-level minimum power to provide a blanket of power or otherwise provide broad, substantially continuous coverage over a particular area of the process control system 100. Thus, if one of the wireless base units 102a-c fails, any of the wireless field units 104a-g corresponding to (e.g., that are in communication with and/or which receive power from) the failed wireless base unit can switch to (e.g., communicate with, receive power from, etc.) another one of the wireless base units 102a-c.

To provide fault tolerant and robust power transmissions and data transmissions, the wireless power and data transmitter 416 may also be configured to transmit power levels or amounts of power as requested by wireless field units and transmit data to the wireless field units using one or more robust transmission methods such as, for example, frequency hopping or simultaneous or redundant transmissions of power and/or data over a plurality of frequency bands. Additionally or alternatively, the wireless power and data transmitter 416 may transmit data and/or power wirelessly using a spread spectrum technique.

A wireless power link and/or a wireless data link may be implemented using one or more wireless transmission channels established between a wireless base unit (e.g., the wireless base unit 402) and a wireless field unit (e.g., the wireless field unit 404). Each of the one or more wireless transmission channels may be implemented using any one or more particular frequency signals. In this manner, the wireless field unit 402 may transmit power and/or data wirelessly to the wireless field unit 404 via a plurality of frequencies using a spread spectrum transmission technique or via a signal composed of substantially a single frequency.

In one example implementation, the wireless base unit 402 may transmit power wirelessly using a frequency hopping technique by establishing a wireless power link capable of transmitting power wirelessly over a plurality of transmission channels or frequency signals and periodically selecting a different one of the plurality of channels or frequency signals during a transmission. Additionally or alternatively, the wireless base unit 402 may transmit power wirelessly using an automatic channel selection technique or an automatic channel switching technique that enables the wireless base unit 402 to automatically select a best channel (e.g., a frequency associated with the least amount of interference) prior to and during transmission. In this manner, the wireless base unit 402 may select a different channel any time a currently selected channel or frequency signal becomes unavailable due to, for example, frequency jamming, interference, etc.

To implement the automatic channel selection or channel switching techniques, the wireless base unit 402 may be communicatively coupled to the wireless field unit 404 via a data channel (e.g., a wireless data link) to exchange control data with the wireless field unit 404 and via a plurality of power channels or frequencies (e.g., a wireless power link) to transmit power wirelessly to the wireless field unit 404. During power transmission the wireless field unit 404 may continuously or periodically measure the signal strength and/or the signal to noise ratio of the power received via one of the power channels to generate link quality status information (e.g., the signal strength, the signal to noise ratio, etc.). The wireless field unit 404 may then transmit the link quality status information to the wireless base unit 402 via the data channel to enable the wireless power unit 402 to select a different channel or frequency if the link quality is less than a particular pre-determined threshold. Of course, the wireless base unit 402 and the wireless field unit 404 may also be configured to exchange data via wireless data links using any of the techniques described above to ensure robust and fault tolerant data communications.

The wireless base unit 402 includes a wireless data receiver 418 to receive data from wireless field units, other wireless base units, and the portable computing device 112 (FIG. 1). For example, the wireless data receiver 418 may be used to receive power request messages, power acknowledge messages, end power transmission messages, or any other message from wireless field units or wireless base units.

The example wireless field unit 404 is configured to receive power transmitted wirelessly by the wireless base unit 402 and to power a field device 420 using the received power. Specifically, the example wireless field unit 404 includes a wireless power and data receiver 422 configured to receive power and data wirelessly transmitted by the wireless base units and/or other wireless field units. The wireless power and data receiver 422 may include RF circuitry to receive power and data transmitted via a plurality of frequencies and/or via spread spectrum. The wireless power and data receiver 422 may also be configured to receive power and data that are transmitted by the wireless base unit 402 using frequency hopping techniques. To enable a user (e.g., the user 114 of FIG. 1) to access process control data in the wireless field unit 404 and/or in the field device 420, the wireless power and data receiver 422 may also be configured to receive data from the portable computing device 112 of FIG. 1.

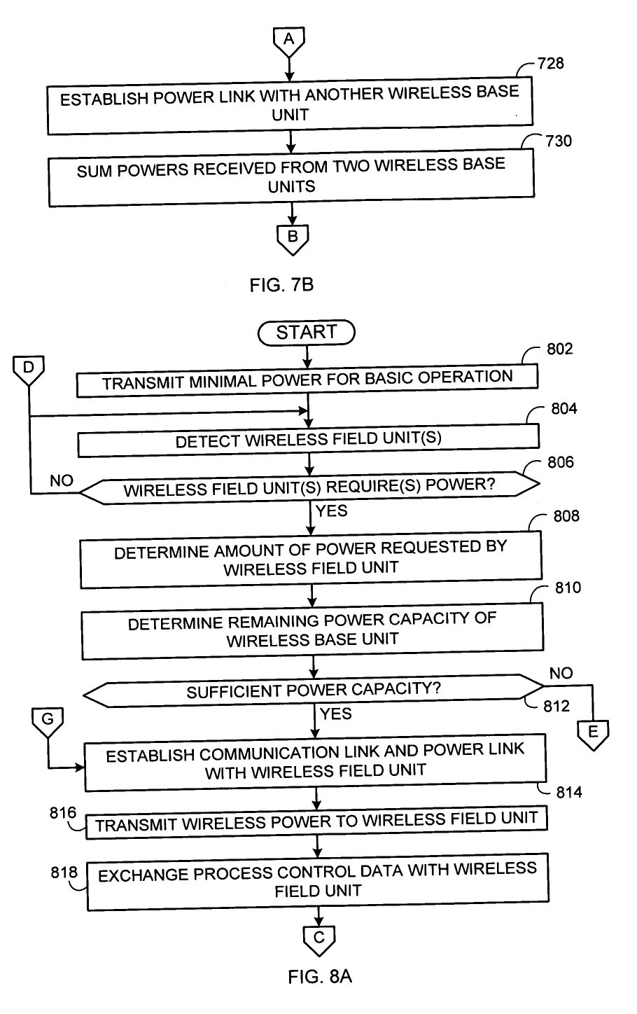

The wireless field unit 404 also includes a power signal conditioner 424. The power signal conditioner 424 is configured to condition the wirelessly received power. For example, the power signal conditioner 424 may rectify the received power and suppress any power surges or current spikes present therein. The power signal conditioner 424 may then send the conditioned power to the field device 420. An example circuit that may be implemented in the power signal conditioner 424 to condition the power is described below in connection with FIG. 6. The power signal conditioner 424 may also be configured to sum a plurality of powers or power signals received via a plurality of frequency signals from one or more wireless base units (e.g., one or more of the wireless base units 102a-c of FIG. 1). For example, the power signal conditioner 424 may include a summing power amplifier circuit to sum two or more power signals as is well known in the art to generate the amount of power required by the field device 420.

The wireless field unit 404 also includes a wireless power and data transmitter 426 that may be configured to transmit data to wireless base units (e.g., the wireless base unit 402), to other wireless field units (e.g., the wireless field units 104a-g of FIG. 1), and/or to the portable computing device 112 (FIG. 1). For example, the wireless power and data transmitter 426 may be used to transmit power request messages, power acknowledge messages, end power transmission messages, or any other message to the wireless base unit 402.

The wireless power and data transmitter 426 enables the wireless field unit 404 to function as a repeater for retransmitting power and data received from a wireless base unit (e.g., the wireless base unit 402 or any of the wireless base units 102a-c of FIGS. 1 and 3) to another wireless field unit (e.g., the wireless field units 104a-g of FIG. 1). In this manner, if a wireless field unit is too far from a nearest wireless base unit or obstructed as described above in connection with FIG. 3, the nearest wireless base unit may transmit power to and exchange data with the too-distant or obstructed wireless field unit via the wireless field unit 404. Specifically, the wireless field unit 404 may obtain power and data associated with the too-distant or obstructed wireless field unit via the wireless power and data receiver 322 and re-transmit the power and data to that wireless field unit via the wireless power and data transmitter 326. The wireless field unit 404 may differentiate or distinguish power and data associated with the wireless field unit 404 from power and data associated with another wireless field unit based on security keys or codes (e.g., wireless field unit ID's or variations thereof) that are unique to the wireless field unit 404 and each of the wireless field units 104a-g.

The wireless field unit 404 includes a rectenna 428 that is coupled to the wireless power and data transmitter 426 and the wireless power and data receiver 422. The rectenna 428 may be used by the wireless power and data transmitter 426 to transmit data to the wireless base unit 402 and the portable computing device 112 (FIG. 1) and to transmit power and data to any other wireless field unit (e.g., the wireless field units 104a-g of FIG. 1) and may be used by the wireless power and data receiver 422 to receive power and data transmissions from the wireless base unit 402 and the portable computing device 112.

The wireless field unit 404 also includes a memory 430 to store communication software or firmware, process control data, run-time variables, or any other type of data, machine-readable and executable instructions or code, etc. The memory 430 may be a shared memory accessible by the wireless power and data receiver 422 and the wireless power and data transmitter 426. The memory 430 may be implemented using any combination of volatile and non-volatile memory. In some implementations, the memory 430 may be implemented using a non-volatile flash memory. The flash memory may be used to store a power requirement of the field device 420. The flash memory may also be used to continuously or periodically store the state of the wireless field unit 404 and/or the field device 420. In this manner, if the wireless field unit 404 loses power, the wireless field unit 404 and the field device 420 can quickly recover after power is restored by retrieving from the flash memory (e.g., the memory 430) previous state information.

Additionally or alternatively, the wireless field unit 404 may continuously or periodically communicate state information to the control equipment 108 (FIG. 1) that is associated with the wireless field unit 404 and the field device 420. In this case, after power is restored following a loss of power or a power failure, the wireless field unit 404 and the field device 420 can retrieve the state information from the control equipment 108 via the wireless base unit 402.

The stored state information may also be used to implement a power conservation routine in which the wireless field unit 404 and the field device 420 are powered down or placed in a low-power mode when full operation of the field device 420 is not required. For example, the field device 420 may enter into a low-power mode when only partial operation of the field device 420 is required. Or, the field device 420 may be turned off when operation of the field device 420 is not required.

FIG. 5 is a detailed schematic of the example signal conditioner 414 of the example wireless base unit 402 of FIG. 4. The example signal conditioner 414 includes a transformer 502 that couples the AC power interface 406 to the wireless power and data transmitter 416. The transformer 502 may be used to isolate or prevent DC signal components from transferring between the AC power interface 406 and the wireless power and data transmitter 416 while maintaining continuous AC transmission from the AC power interface 406 to the wireless power and data transmitter 416. The transformer 502 may also be used to step-up or step-down voltages.

FIG. 6 is a detailed schematic of the example power signal conditioner 424 of the example wireless field unit 404 of FIG. 4. The example power signal conditioner 424 includes a transformer 602 that couples the wireless power and data receiver 422 to the field device 420. The transformer 602 may be used to perform functions substantially similar or identical to those performed by the transformer 502 of the example signal conditioner 414 as described above in connection with FIG. 5. However, instead of conditioning power received from an AC power source (e.g., the AC power source 408 of FIG. 4), the transformer 602 is used to condition the wirelessly transmitted power received by the wireless power and data receiver 422.

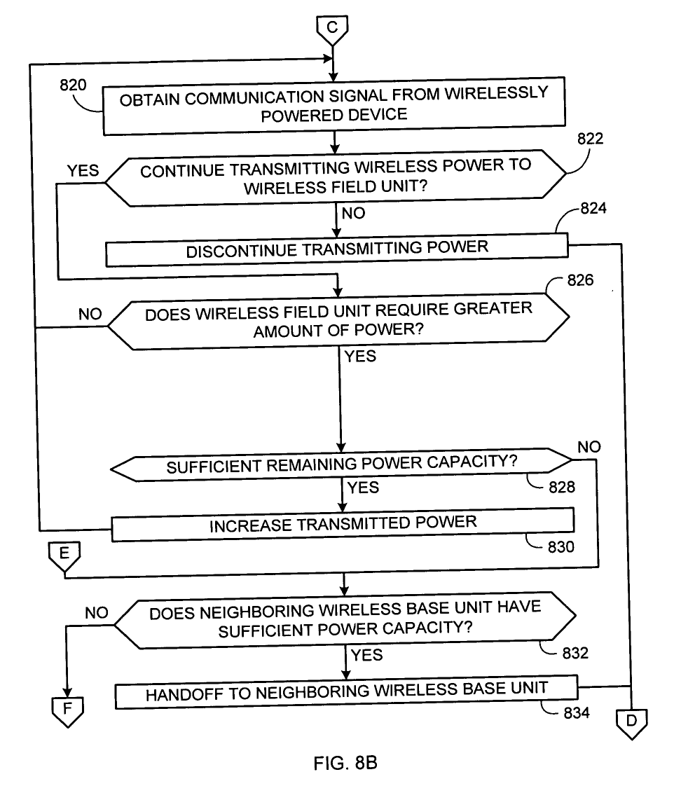

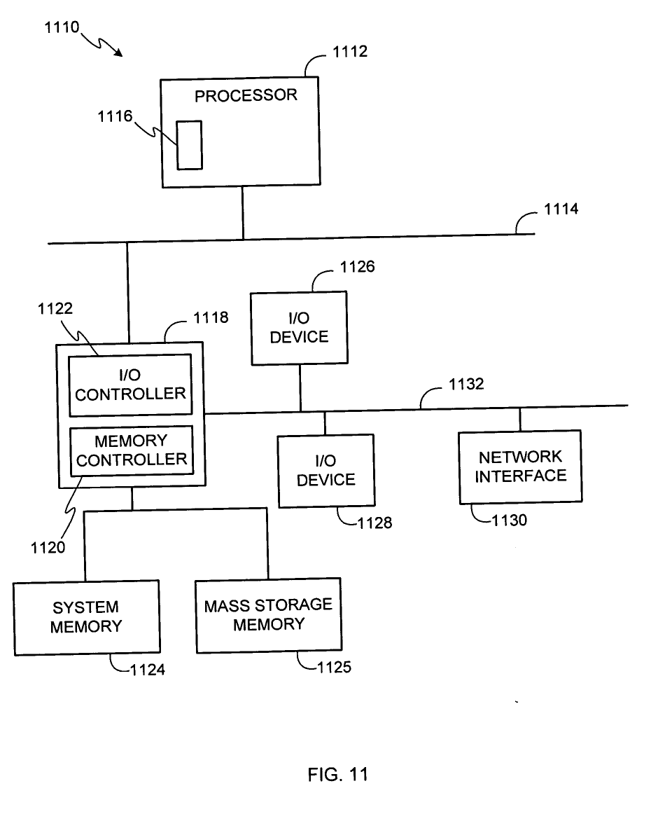

FIGS. 7A through 10 are flow diagrams that depict example methods that may be used to transmit wireless power using wireless base units (e.g., the example wireless base unit 402 of FIG. 4 and/or the example wireless base units 102a-c of FIG. 1) and wireless field units (e.g., the example wireless field unit 404 of FIG. 4 and/or the example wireless field units 104a-g of FIG. 1). The example methods depicted in the flow diagrams of FIGS. 7A through 10 may be implemented in software, hardware, and/or any combination thereof. For example, the example methods may be implemented in software that is executed via the example processor system 1110 of FIG. 11 and/or a hardware system configured according to the example wireless base unit 402 of FIG. 4 and/or the example wireless field unit 404 of FIG. 4.

Although, the example methods are described below as a particular sequence of operations, one or more operations may be rearranged, added, and/or eliminated to achieve the same or similar results. In addition, although the example methods described below in connection with FIGS. 7A through 10 may be implemented in connection with any of the wireless base units 402 (FIG. 4) and 102a-c (FIG. 1) and any of the wireless field units 404 (FIG. 4) and 104a-g (FIG. 1), for purposes of simplicity, the example methods of FIGS. 7A through 10 are generally described with respect to the wireless base unit 402 and the wireless field unit 404.

FIG. 7 is a flowchart illustrating an example method that may be used to implement the example wireless field unit 404 of FIG. 4. Initially, the example wireless field unit 404 receives minimal power for basic operation (block 702). For example, the wireless base unit 402 may continuously transmit on a selected frequency a minimum amount of power required for basic communications operation of a wireless field unit (e.g., the wireless field unit 404). In this manner, the wireless field unit 404 can receive the minimal power and power its communications circuitry (e.g., the wireless power and data receiver 422, the wireless power and data transmitter 426, and the memory 430 of FIG. 4) using the minimal power to establish a communication link with the wireless base unit 402 or any other wireless base unit.

After the wireless field unit 404 powers up its communications circuitry using the minimal power obtained at block 702, the wireless field unit 404 determines a power requirement associated with the field device 420 (block 704). For example, the wireless field unit 404 may obtain the power requirement from the field device 420 or from the memory 430 (if the power requirement is stored in the memory 430).

The wireless power and data transmitter 426 then broadcasts a power request message (block 706). The power request indicates to wireless base units (e.g., the wireless base unit 402) that the wireless field unit 404 seeks to establish a wireless communication link and a wireless power link and to receive wirelessly transmitted power in an amount sufficient to fulfill or satisfy or that is equivalent to the power requirement of the field device 420 determined at block 704. The power request at block 706 may include an identification code or address of the wireless field unit 404. The power request may also include the amount of power requested by the wireless field unit 404 that corresponds to the amount of power required for full operation of the field device 420 and/or for powering other portions of the wireless field unit 404 such as, for example, the power signal conditioner 424.

The wireless power and data receiver 422 then obtains an acknowledgment from a wireless base unit (e.g., the wireless base unit 402 of FIG. 4) that received the power request (block 708). For example, the wireless power and data receiver 422 may receive the acknowledgment from the wireless base unit 402 via a wireless data link. The acknowledgment may indicate that the wireless base unit 402 is capable of supplying the requested amount of power to the wireless field unit 404.

The wireless power and data receiver 422 then establishes a communication link and a power link with the wireless base unit 402 (block 710) and begins to receive wirelessly transmitted power, at least some of which the wireless field unit 404 transfers to the field device 420 of FIG. 4. The wireless power and data receiver 422 may use the wireless communication link to exchange configuration data and process control data with the wireless base unit 402. The wireless power and data receiver 422 may obtain configuration information from the wireless base unit 402 (block 712) and/or any other process control data that the control equipment 108 (FIG. 1) needs to communicate to the wireless field unit 404 and/or the field device 420. The wireless power and data receiver 422 may receive encrypted power at block 710 via the wireless power link and encrypted data at block 712 via the wireless communication link and decrypt the encrypted power and data. For example, the wireless base unit 402 may encrypt the transmitted power and data using a security key or a code (e.g., a wireless field unit ID or variation thereof) that is unique to the wireless field unit 404. In this manner, any wireless field unit other than the wireless field unit 404 cannot decrypt and use the power or access the data.

The wireless field unit 404 then determines whether a greater power level is required (block 714). For example, the wireless field unit 404 may determine if the field device 420 is operating in a particular mode or otherwise performing operations that require a greater level or amount of power. If the wireless field unit 404 determines that a greater power level is required, the wireless power and data transmitter 426 transmits a message to the wireless base unit 402 requesting an increased power level (block 716). The wireless power and data receiver 422 then receives an acknowledge message from the wireless base unit 402 (block 718). The acknowledge message indicates whether the wireless base unit 402 can supply all of the additional power required to achieve the increased power level, a portion of the increased power level, or none of the increased power level.

The wireless field unit 404 then determines whether it will receive the increased power from two or more wireless base units (block 720) based on, for example, the acknowledge message received at block 718. If the wireless field unit 404 will not receive the increased power from two or more wireless base units, the wireless field unit 404 determines whether it will receive the increased power from the same wireless base unit (e.g., the wireless base unit 402) (block 722) with which it established a power link at block 710.

If the wireless field unit 404 determines at block 722 that it will not receive the increased power from the same wireless base unit, the wireless field unit 404 establishes a power link with a next or another wireless base unit (block 724) and terminates the power link established with a previous wireless base unit at block 710 (block 726). The wireless field unit 404 may also establish a communication link with the next wireless base unit at block 724. At block 724, if the next wireless base unit is too far from the wireless field unit 404 to establish a power link or if an RF-impermeable or RF-attenuating object (e.g., a wall, a holding vessel, a mixer, etc.) is disposed or located between the next wireless base unit and the wireless field unit 404, the wireless field unit 404 may establish a power link and a communication link with the next wireless base unit via another wireless field unit (e.g., one of the wireless field units 104a-g of FIG. 1) as described above in connection with FIG. 3. In this case, another wireless field unit functions as a repeater between the wireless field unit 404 and the next wireless base unit.

If at block 720 the wireless field unit 404 determines that the increased power will be received from two or more wireless base units, the wireless power and data receiver 422 establishes another power link with another wireless base unit (block 728) (FIG. 7B). The wireless power and data receiver 422 and/or the power signal conditioner 424 then sum the powers received from two wireless base units (e.g., the wireless base unit 402 of FIG. 4 and another wireless base unit) (block 730). For example, the power signal conditioner 424 may include a summing power amplifier as described-above to sum a plurality of power signals as is known in the art.

After the wireless field unit 404 sums the received powers at block 730, or after the wireless field unit 404 has terminated the previously established power link at block 726, or if the wireless field unit 404 determines at block 404 that a greater power level is not required, the wireless field unit 404 checks to determine if there has been a wireless base unit failure (block 732). If there has been a wireless base unit failure, control is passed back to block 702 to establish a power link with a different or next wireless base unit. If the next wireless base unit is too far or obstructed, the operations described above to establish power and communication links with a wireless base unit (e.g., a next wireless base unit) may be implemented by using another wireless field unit (e.g., one of the wireless field units 104a-g) as a repeater between the wireless field unit 404 and the next wireless base unit as described above in connection with FIG. 3.

If there has not been a wireless base unit failure, the wireless field unit 404 determines if an attached device (e.g., the field device 420 of FIG. 4) has been turned off (block 734). If the wireless field unit 404 determines that the field device 420 is not turned off, control is passed back to block 714 to again determine if a greater power level is required. However, if the wireless field unit 404 determines at block 730 that the field device 420 is turned off, the wireless field unit 404 terminates the power link with the wireless base unit(s) (e.g., the wireless base unit 402 and any other wireless base unit with which the wireless field unit 404 established a power link) (block 736) and the process is ended.

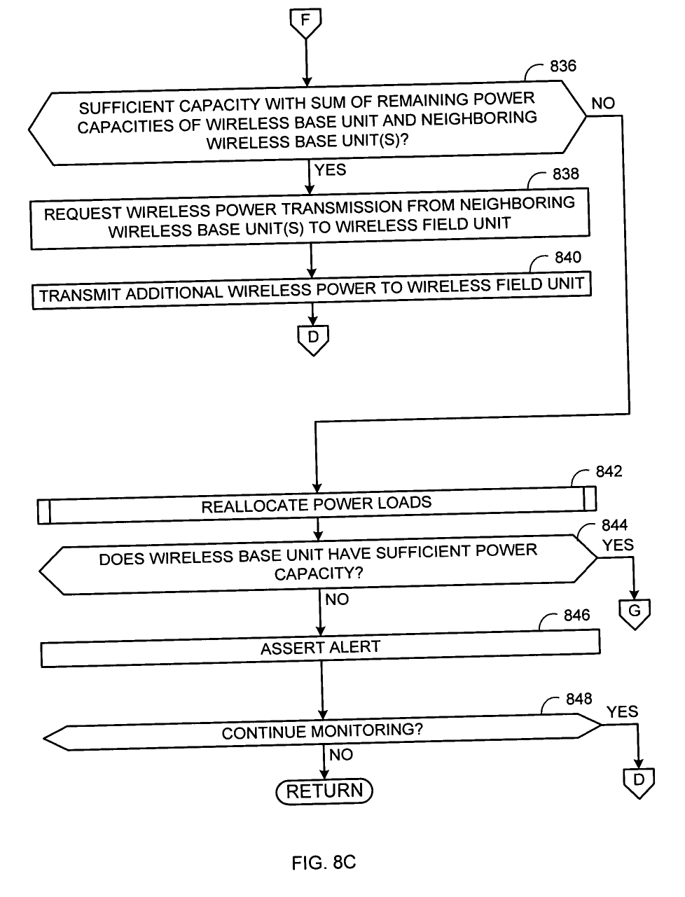

FIGS. 8A-8C are flowcharts illustrating an example method that may be used to implement the example wireless base unit 402 of FIG. 4. Initially, the wireless power and data transmitter 416 transmits a minimal power for basic operation of wireless field units (e.g., the wireless field unit 404 of FIG. 4 and/or any of the wireless field units 104a-g of FIG. 1) (block 802). As described above in connection with block 702, one or more wireless field units may obtain the minimal power to power up their communications circuits and broadcast power request messages.

The wireless data receiver 418 then detects one or more wireless field units (block 804). For example, the wireless data receiver 418 may detect a wireless field unit (e.g., the wireless field unit 404 of FIG. 4) that is added to or moved to a process control area associated with the wireless base unit 402. The wireless base unit 402 then determines if any of the detected wireless field units require power (block 806). For example, the wireless base unit 402 may receive a power request message broadcast by the wireless field unit 404 as described above in connection with block 706 (FIG. 7) and determine that the wireless field unit 404 requires power. If none of the wireless field units requires power then control is passed back to block 804.

If the wireless base unit 402 determines at block 806 that the wireless field unit 404 requires power, the wireless base unit 402 determines the amount of power requested by the wireless field unit 404 (block 808). Then the wireless base unit 402 determines its remaining power capacity (block 810). The power capacity of the wireless base unit 402 may be associated with a power capacity limitation of a power source (e.g., the AC power interface 406, the AC power source 408 of FIG. 4, or a DC power source) or the power rating of the electronic circuits of the wireless base unit 402 or the amount of power that can be transmitted wirelessly via RF (e.g., to maintain safe RF power levels). The wireless base unit 402 may determine its remaining power capacity by retrieving the power values stored in a power requirement column of a power requirement table (e.g., the power requirement column 204 of the example power requirement table 200 of FIG. 2) of the wireless base unit 402, adding all of the power values, and subtracting the sum of all the power values from the power capacity limit of the wireless base unit 402.

The wireless base unit 402 then determines if it has sufficient power capacity (block 812). For example, the wireless base unit 402 may compare the remaining power capacity determined at block 810 to the amount of power required by the wireless base unit 404 determined at block 808. If the wireless base unit 402 determines that it has sufficient power capacity, the wireless base unit 402 establishes a communication link and a power link with the wireless field unit 404 (block 814). For example, the wireless base unit 402 may transmit a message to the wireless field unit 404 indicating that the wireless base unit 402 can supply the requested power and is ready to establish a wireless power link with the wireless field unit 404. After establishing the wireless power link, the wireless base unit 402 then transmits wireless power to the wireless field unit 404 (block 816). For example, the wireless base unit 402 may transmit power wirelessly to the wireless field unit 404 via the wireless power link using one or more transmission channels and/or frequency signals and any type of transmission technique (e.g., a single or fixed frequency transmission technique, a frequency hopping transmission technique, a spread spectrum transmission technique, etc.). The wireless base unit 402 may then exchange process control data with the wireless field unit 404 (block 818). Any transmitted data may be encrypted prior to transmission using, for example, a security key or code, and any received data may be decrypted using, for example, the security key or code.

The wireless base unit 402 may then obtain a communication signal or message from the wireless field unit 404 (block 820) (FIG. 8B). The message may include control information associated with wireless power delivery. For example, the message may indicate that the wireless base unit 402 should stop transmitting power or that the wireless field unit 404 requires a greater power level. The wireless base unit 402 then determines whether to continue transmitting wireless power to the wireless field unit 404 (block 822). If the wireless base unit 402 determines that it should not continue transmitting power to the wireless field unit 404, the wireless base unit 402 terminates the power link with the wireless field unit 404 and discontinues transmitting power to the wireless field unit 404 (block 822). Control is then passed back to block 804.

If the wireless base unit 402 determines at block 822 that it should continue transmitting wireless power to the wireless field unit 404, the wireless base unit 402 determines if the wireless field unit 404 requires a greater amount of power (block 826). For example, the message received at block 820 may indicate that the wireless field unit 404 is requesting an increased power level. If the wireless field unit 404 does not require an increased amount of power, control is passed back to block 820.

If the wireless base unit 402 determines at block 826 that the wireless field unit 404 is requesting a greater power level, then the wireless base unit 402 determines whether it has sufficient remaining power capacity to transmit the requested increase in power (block 828). The wireless base unit 402 may determine its remaining power capacity based on its total power capacity and the power requirement values listed in its power requirement tables (e.g., the example power requirement table 200 of FIG. 2) as described above in connection with FIG. 2. If the wireless base unit 402 has sufficient remaining power capacity, the wireless base unit 402 increases the amount of power transmitted to the wireless field unit 404 (block 830).

If the wireless base unit 402 determines at block 828 or at block 812 (FIG. 8A) that it does not have sufficient power capacity, the wireless base unit 402 determines whether a neighboring wireless base unit has sufficient power capacity (block 832) to supply the requested increased amount of power to the wireless field unit 404. For example, the wireless base unit 402 may communicate with neighboring wireless base units via the wireless power and data transmitter 416 and the wireless data receiver 418. If a neighboring wireless base unit has sufficient power capacity, the wireless base unit 402 hands off the wireless field unit 404 to the neighboring wireless base unit (block 834) and control is passed back to block 804.

If the wireless base unit 402 determines at block 832 that a neighboring wireless base unit does not have sufficient power capacity to supply the requested increased amount of power, the wireless base unit 402 determines whether the sum of its remaining power capacity and the remaining power capacities of one or more neighboring wireless base units is sufficient to supply the requested increased amount of power (block 836) (FIG. 8C). For example, the wireless base unit 402 may be communicatively coupled to other wireless base units via the network 110 or via the wireless power/data transmitter 416 and the wireless data receiver 418 and configured to exchange power capacity information with the other wireless base units. For instance, each of the wireless base units 102a-c of FIG. 1 may continuously or periodically determine its remaining power capacity based on its total power capacity and the power requirement values listed in its power requirement table (e.g., the example power requirement table 200 of FIG. 2) as described above in connection with FIG 2. Each of the wireless base units 102a-c may then continuously or periodically or upon request of another one of the wireless base units 102a-c communicate its remaining power capacity value to the other ones of the wireless base units 102a-c via a data transmission. After the wireless base unit 402 receives the remaining power capacity values of one or more neighboring wireless base units using a substantially similar or identical process, the wireless base unit 402 may add the remaining power capacity values to determine if the sum of its remaining power capacity and the remaining power capacities of one or more neighboring wireless base units is sufficient to supply the requested increased amount of power via a plurality of wireless base units to the wireless field unit 404.

If the wireless base unit 402 determines that the sum of power capacities is sufficient to supply the requested increased amount of power, the wireless base unit 402 communicates a request to one or more neighboring wireless base units to transmit wireless power to the wireless field unit 404 (block 838) and the wireless base unit 402 transmits additional wireless power to the wireless field unit 404 (block 840). For example, the wireless base unit 402 may determine based on the number of neighboring wireless base units and the remaining power capacity values of the neighboring wireless base units the number of the neighboring wireless base units required and the amount of power required by each of the neighboring wireless base units to supply the requested power to the wireless field unit 404. After determining the number of required neighboring wireless base units and the amount of power required from each, the wireless base unit 402 may transmit to the selected neighboring wireless base units a power request, the amount of power required by each of the wireless base units, and the wireless field unit ID of the wireless field unit 404. In this manner, each of the selected neighboring wireless base units may embed the wireless field unit ID in a power signal using any technique well-known in the art (e.g., FSK, PSK, frequency modulation, amplitude modulation, etc.) and transmit the power signal to the wireless field unit 404. The wireless field unit 404 may obtain a plurality of wirelessly transmitted power signals and select those power signals having embedded therein the wireless field unit ID associated with the wireless field unit 404 and sum the received power signals using, for example, a summing amplifier as is well known in the art to generate the required power. In some implementations, the wireless base unit 402 may also transmit to each of the selected neighboring wireless base units a frequency value indicating a frequency at which to transmit a power signal to the wireless field unit 404. After the wireless base unit 402 and the selected neighboring wireless base units transmit wireless power to the wireless field unit 404 control is passed back to block 804.

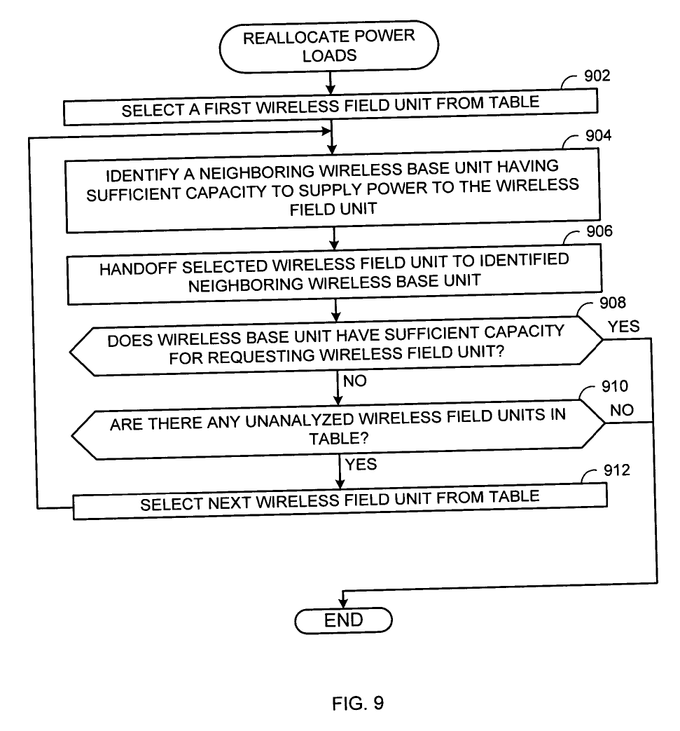

If the wireless base unit 402 determines at block 836 that the sum of power capacities is not sufficient to supply the requested increased amount of power, then the wireless base unit 402 and one or more neighboring wireless base units reallocate power loads (block 842) associated with wireless field units. The power loads are reallocated by handing off wireless field units (e.g., the wireless field units 104a-g of FIG. 1) among neighboring wireless base units (e.g., the wireless base units 102a-c of FIG. 1) to free up enough power capacity of one wireless base unit to enable the wireless base unit to transmit the requested amount of wireless power to the wireless field unit 404. An example load reallocation loads process is described in greater detail below in connection with FIG. 9.

After reallocating power loads, the wireless base unit 404 determines if it has sufficient power capacity (block 844). If the wireless base unit 404 has sufficient power capacity, control is passed back to block 814 to establish a power link with the wireless field unit 404. However, if the wireless base unit 402 does not have sufficient power capacity, the wireless base unit 402 asserts an alert (block 846). The alert may be asserted using an email message, a light indicator, a pop-up computer display message, an audible alarm, or any other means suitable to indicate that the request of a wireless field unit cannot be fulfilled or serviced.

After the alert is asserted, the wireless base unit 402 determines whether it should continue monitoring for messages from wireless field units or other wireless base units (block 848). For example, the wireless base unit 402 may be configured to shutdown or enter a standby mode if it is malfunctioning. The wireless base unit 402 may be malfunctioning if it has no wireless field unit ID's listed in its power requirement table (e.g., the wireless power requirement table 200), but is nonetheless incapable of transmitting power. In this case, if the wireless base unit 402 determines that it has no wireless field unit ID's listed in its power requirement table, but is still unable to service the request of the wireless field unit 404, then the wireless base unit 402 determines that it should not continue monitoring and the process is ended. Otherwise control is passed back to block 804. Of course, any other criteria such as, for example, time of day, reception of on or off control commands, etc., may also be used to determine whether the wireless base unit 402 should continue to monitor for messages from wireless field units or other wireless base units at block 848.

FIG. 9 is a flowchart of an example method that may be used to reallocate power loads among a plurality of wireless base units (e.g., the wireless base unit 402 of FIG. 4 and the wireless base units 102a-c of FIG. 1). The example method of FIG. 9 may be used to implement the operation of block 842 of FIG. 8C. Initially, the wireless base unit 402 (or one of the wireless base units 102a-c) selects a first wireless field unit 404 (or one of the wireless field units 104a-g) from the power requirement table 200 (FIG. 2) (block 902) and identifies a neighboring wireless base unit having sufficient capacity to supply power to the wireless field unit 404 (block 904). The wireless base unit 402 then hands off the wireless field unit 404 to an identified neighboring wireless base unit (block 906).

The wireless base unit 402 then determines if it has sufficient power capacity to supply a particular amount of power to a requesting wireless field unit (e.g., the wireless field unit requesting power at blocks 808 of FIG. 8A or the wireless field unit requesting an increased power level at block 826 of FIG. 8B) (block 908). If the wireless base unit 402 has sufficient power capacity, the process is ended. However, if the wireless base unit 402 does not have sufficient power capacity, the wireless base unit 402 determines if there are any remaining unanalyzed wireless field units in the power requirement table 200 (block 910). If there are unanalyzed wireless field units, a next wireless field unit 404 is selected from the power requirement table 200 (block 912) and control is passed back to block 904. If there are no unanalyzed wireless field units, the process is ended.

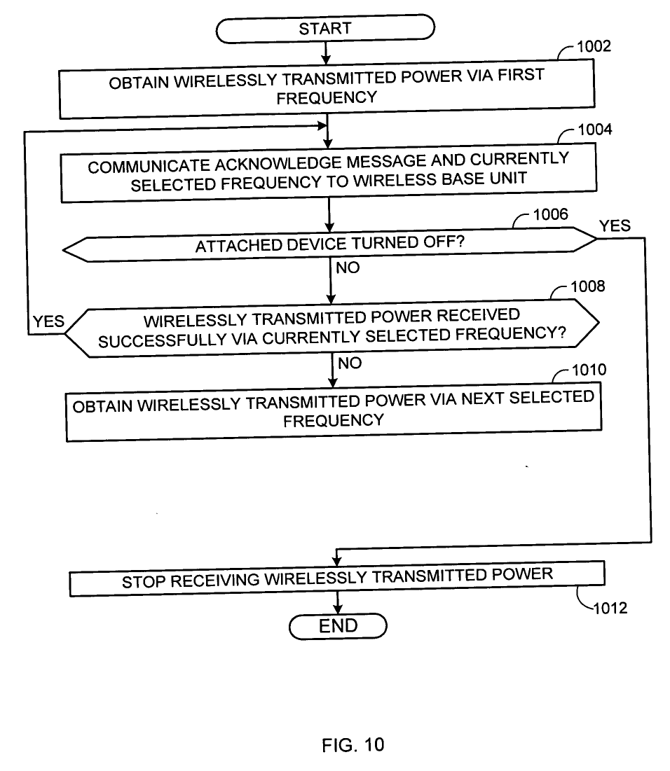

FIG. 10 is a flowchart of an example method that may be used to receive via one or more wireless field units (e.g., the wireless field unit 404 of FIG. 4 and/or one or more of the wireless field units 104a-g of FIG. 1) power and data that is transmitted redundantly via a plurality of frequencies from a wireless base unit (e.g., the wireless base unit 402 of FIG. 4 or one of the wireless base units 102a-c of FIG. 1). Initially, the wireless field unit 404 obtains wirelessly transmitted power via a first frequency (block 1002). The wireless field unit 404 then communicates an acknowledge message and the currently selected frequency to the wireless base unit 402 (block 1004). The acknowledge message informs the wireless base unit 402 that the wireless field unit 404 is successfully receiving power from the wireless base unit 402.

The wireless field unit 404 then determines if an attached device (e.g., the field device 420 of FIG. 4) is turned off (block 1006). If the field device 420 is not turned off, the wireless field unit 404 determines if it is successfully receiving the wirelessly transmitted power at the currently selected frequency (block 1008). For example, the wireless power and data receiver 422 may monitor the wireless power received at the selected frequency for a wireless field unit ID associated with the wireless field unit 404 and, if the wireless power and data receiver 422 does not detect the wireless field unit ID within a predetermined time threshold, the wireless field unit 404 may determine that it is not successfully receiving the wirelessly transmitted power. Alternatively or additionally, the wireless power and data receiver 422 or the power signal conditioner 424 may monitor signal strength or signal to noise ratio of the wireless power received at the selected frequency and, if the signal strength or signal to noise ratio exceeds (e.g., is less than or is greater than) a predetermined threshold, the wireless field unit 404 may determine that it is not successfully receiving the wirelessly transmitted power. If the wireless field unit 404 determines at block 1008 that it is successfully receiving the wireless power via the selected frequency, control is passed back to block 1004.

If the wireless field unit 404 is not successfully receiving the wireless power, the wireless field unit 404 obtains wirelessly transmitted power via a next selected frequency (block 1010). For example, the wireless base unit 402 may transmit the same amount of power via a plurality of frequencies to enable robust or fault tolerant power delivery. In this manner, if a particular frequency is jammed or inhibited by an interfering signal, the wireless field unit 404 can operate using power wirelessly transmitted on other frequencies. After obtaining power from a different frequency, control is passed back to block 1004.

If the wireless field unit 404 determines at block 1006 that the field device 420 is turned off, the wireless field unit 404 stops receiving wirelessly transmitted power from the wireless base unit 402 (block 1012) and the process is ended.

FIG. 11 is a block diagram of an example processor system that may be used to implement the example apparatus, methods, and articles of manufacture described herein. As shown in FIG. 11, the processor system 1110 includes a processor 1112 that is coupled to an interconnection bus 1114. The processor 1112 includes a register set or register space 1116, which is depicted in FIG. 11 as being entirely on-chip, but which could alternatively be located entirely or partially off-chip and directly coupled to the processor 1112 via dedicated electrical connections and/or via the interconnection bus 1114. The processor 1112 may be any suitable processor, processing unit or microprocessor. Although not shown in FIG. 11, the system 1110 may be a multi-processor system and, thus, may include one or more additional processors that are identical or similar to the processor 1112 and that are communicatively coupled to the interconnection bus 1114.

The processor 1112 of FIG. 11 is coupled to a chipset 1118, which includes a memory controller 1120 and an input/output (I/O) controller 1122. As is well known, a chipset typically provides I/O and memory management functions as well as a plurality of general purpose and/or special purpose registers, timers, etc. that are accessible or used by one or more processors coupled to the chipset 1118. The memory controller 1120 performs functions that enable the processor 1112 (or processors if there are multiple processors) to access a system memory 1124 and a mass storage memory 1125.

The system memory 1124 may include any desired type of volatile and/or non-volatile memory such as, for example, static random access memory (SRAM), dynamic random access memory (DRAM), flash memory, read-only memory (ROM), etc. The mass storage memory 1125 may include any desired type of mass storage device including hard disk drives, optical drives, tape storage devices, etc.

The I/O controller 1122 performs functions that enable the processor 1112 to communicate with peripheral input/output (I/O) devices 1126 and 1128 and a network interface 1130 via an I/O bus 1132. The I/O devices 1126 and 1128 may be any desired type of I/O device such as, for example, a keyboard, a video display or monitor, a mouse, etc. The network interface 1130 may be, for example, an Ethernet device, an asynchronous transfer mode (ATM) device, an 802.11 device, a DSL modem, a cable modem, a cellular modem, etc. that enables the processor system 1110 to communicate with another processor system.

While the memory controller 1120 and the I/O controller 1122 are depicted in FIG. 11 as separate functional blocks within the chipset 1118, the functions performed by these blocks may be integrated within a single semiconductor circuit or may be implemented using two or more separate integrated circuits.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A method of powering a device using wirelessly transmitted power, comprising:
obtaining via a wireless base unit a request for wireless power;
determining a power requirement associated with a wireless field unit;
comparing the power requirement to a remaining power capacity of the wireless base unit; and
transmitting power wirelessly via the wireless base unit to the wireless field unit based on the comparison of the power requirement to the remaining power capacity, wherein the wirelessly transmitted power is associated with powering a field device operatively coupled to the wireless field unit.

2. The method as defined in claim 1, wherein the remaining power capacity is associated with at least one of a safe radio frequency power level or a power capacity limitation associated with a power source.

3. The method as defined in claim 1, wherein wirelessly transmitting power via the wireless base unit comprises wirelessly transmitting power using at least one of a frequency hopping technique or a spread spectrum technique.

4. The method as defined in claim 1 further comprising exchanging process control data between the wireless base unit and the wireless field unit.

5. The method as defined in claim 4, wherein exchanging process control data comprises encrypting or decrypting the process control data.

6. An apparatus for powering a device using wirelessly transmitted power, comprising:
a processor system; and
a memory communicatively coupled to the processor system, the memory including stored instructions that enable the processor system to:
obtain a request for wireless power;
determine a power requirement associated with a wireless field unit;
compare the power requirement to a remaining power capacity of a wireless base unit; and
transmit power wirelessly to the wireless field unit based on the comparison of the power requirement to the remaining power capacity, wherein the wirelessly transmitted power is associated with powering a field device operatively coupled to the wireless field unit.

7. The apparatus as defined in claim 6, wherein the remaining power capacity is associated with at least one of a safe radio frequency power level or a power capacity limitation associated with a power source.

8. The apparatus as defined in claim 6, wherein the instructions enable the processor system to transmit power wirelessly using at least one of a frequency hopping technique or a spread spectrum technique.

9. The apparatus as defined in claim 6, wherein the instructions enable the processor system to exchange process control data between a wireless base unit and the wireless field unit.

10. The apparatus as defined in claim 9, wherein the instructions enable the processor system to encrypt or decrypt the process control data.

11. A machine accessible medium having instructions stored thereon that, when executed, cause a machine to:
obtain a request for wireless power;
determine a power requirement associated with a wireless field unit;
compare the power requirement to a remaining power capacity of a wireless base unit; and
transmit power wirelessly to the wireless field unit based on the comparison of the power requirement to the remaining power capacity, wherein the wirelessly transmitted power is associated with powering a field device operatively coupled to the wireless field unit.

12. The machine accessible medium as defined in claim 11, wherein the remaining power capacity is associated with at least one of a safe radio frequency power level or a power capacity limitation associated with a power source.

13. The machine accessible medium as defined in claim 11 having instructions stored thereon that, when executed, cause the machine to transmit power wirelessly using at least one of a frequency hopping technique or a spread spectrum technique.

14. The machine accessible medium as defined in claim 11 having instructions stored thereon that, when executed, cause the machine to exchange process control data between a wireless base unit and the wireless field unit.

15. The machine accessible medium as defined in claim 14 having instructions stored thereon that, when executed, cause the machine to encrypt or decrypt the process control data.

16. A method of receiving wirelessly transmitted power, comprising:
receiving a low-power transmission via a wireless field unit;
powering a communications circuit of the wireless field unit using the low-power transmission;
communicating via the wireless field unit a power request message;
receiving wirelessly transmitted power associated with the power request message; and
powering a field device using the wirelessly transmitted power.

17. The method as defined in claim 16, wherein the low-power transmission is obtained via a fixed frequency signal.

18. The method as defined in claim 16, wherein the communications circuit is configured to at least one of transmit data, receive data, or receive wirelessly transmitted power.

19. The method as defined in claim 16 further comprising determining whether an increased power level is required based on the field device.

20. The method as defined in claim 16 further comprising decrypting the wirelessly transmitted power.

21. The method as defined in claim 16, wherein communicating the power request message comprises encrypting the power request message.

22. The method as defined in claim 16 further comprising determining a power requirement of the field device prior to communicating the power request message.

23. The method as defined in claim 16, wherein the wirelessly transmitted power is transmitted using a spread spectrum technique.

24. The method as defined in claim 16, wherein receiving the wirelessly transmitted power associated with the power request message comprises receiving the wirelessly transmitted power via a signal having a first frequency.

25. The method as defined in claim 24 further comprising:
receiving the wirelessly transmitted power via a signal having a second frequency; and
powering the field device using the wirelessly transmitted power received via the signal having the second frequency.

26. An apparatus for receiving wirelessly transmitted power, comprising:
a processor system; and
a memory communicatively coupled to the processor system, the memory including stored instructions that enable the processor system to:
obtain a low-power transmission;
power a communications circuit using the low-power transmission;
transmit a power request message;
receive wirelessly transmitted power associated with the power request message; and
power a field device using the wirelessly transmitted power.

27. The apparatus as defined in claim 26, wherein the instructions enable the processor system to obtain the low-power transmission via a fixed frequency signal.

28. The apparatus as defined in claim 26, wherein the instructions enable the processor system to at least one of transmit data, receive data, or receive wirelessly transmitted power via the communications circuit.

29. The apparatus as defined in claim 26 wherein the instructions enable the processor system to determine whether an increased power level is required based on the field device.

30. The apparatus as defined in claim 26 wherein the instructions enable the processor system to decrypt the wirelessly transmitted power.

31. The apparatus as defined in claim 26, wherein the instructions enable the processor system to encrypt the power request message.

32. The apparatus as defined in claim 26 wherein the instructions enable the processor system to determine a power requirement of the field device prior to communicating the power request message.

33. The apparatus as defined in claim 26, wherein the instructions enable the processor system to transmit the wirelessly transmitted power using a spread spectrum technique.

34. The apparatus as defined in claim 26, wherein the instructions enable the processor system to receive the wirelessly transmitted power via a signal having a first frequency.

35. The apparatus as defined in claim 34 wherein the instructions enable the processor system to:
receive the wirelessly transmitted power via a signal having a second frequency; and
power the field device using the wirelessly transmitted power received via the signal having the second frequency.

36. A machine accessible medium having instructions stored thereon that, when executed, cause a machine to:
obtain a low-power transmission;
power a communications circuit using the low-power transmission;
transmit a power request message;
receive wirelessly transmitted power associated with the power request message; and
power a field device using the wirelessly transmitted power.

37. The machine accessible medium as defined in claim 36 having instructions stored thereon that, when executed, cause the machine to obtain the low-power transmission via a fixed frequency signal.

38. The machine accessible medium as defined in claim 36 having instructions stored thereon that, when executed, cause the machine to at least one of transmit data, receive data, or receive wirelessly transmitted power via the communications circuit.

39. The machine accessible medium as defined in claim 36 having instructions stored thereon that, when executed, cause the machine to determine whether an increased power level is required based on the field device.

40. The machine accessible medium as defined in claim 36 having instructions stored thereon that, when executed, cause the machine to decrypt the wirelessly transmitted power.

41. The machine accessible medium as defined in claim 36 having instructions stored thereon that, when executed, cause the machine to encrypt the power request message.

42. The machine accessible medium as defined in claim 36 having instructions stored thereon that, when executed, cause the machine to determine a power requirement of the field device prior to communicating the power request message.

43. The machine accessible medium as defined in claim 36 having instructions stored thereon that, when executed, cause the machine to transmit the wirelessly transmitted power using a spread spectrum technique.

44. The machine accessible medium as defined in claim 36 having instructions stored thereon that, when executed, cause the machine to receive the wirelessly transmitted power via a signal having a first frequency.

45. The machine accessible medium as defined in claim 44 having instructions stored thereon that, when executed, cause the machine to:
receive the wirelessly transmitted power via a signal having a second frequency; and
power the field device using the wirelessly transmitted power received via the signal having the second frequency.

46. A method of managing wireless power transmission, comprising:
wirelessly transmitting power via a first wireless base unit to a wireless field unit based on a first power requirement and powering a field device associated with the wireless field unit using the wirelessly transmitted power;
obtaining a request from the wireless field unit to increase the wirelessly transmitted power to a second power requirement;
comparing the second power requirement to a remaining power capacity associated with the first wireless base unit; and
wirelessly transmitting power to the wireless field unit based on the second power requirement and the comparison of the second power requirement to the remaining power capacity.

47. The method as defined in claim 46, wherein wirelessly transmitting power to the device based on the second power requirement comprises wirelessly transmitting power via at least one of the first wireless base unit and a second wireless base unit.

48. The method as defined in claim 46 further comprising encrypting the wirelessly transmitted power.

49. The method as defined in claim 46 further comprising decrypting the request from the wireless field unit.

50. The method as defined in claim 46 further comprising wirelessly transmitting power via the first wireless base unit using at least one of a frequency hopping technique or a spread spectrum technique.

51. The method as defined in claim 46, wherein wirelessly transmitting power to the wireless field unit based on the second power requirement and the comparison of the second power requirement to the remaining power capacity comprises reallocating power loads associated with at least another wireless field unit between the first wireless base unit and at least another wireless base unit.

52. The method as defined in claim 46, wherein the remaining power capacity is associated with at least one of a safe radio frequency power level and a power capacity limitation associated with a power source.

53. A system for transmitting power wirelessly, comprising:
at least one wireless field unit communicatively coupled to a field device;
at least one wireless base unit communicatively coupled to the wireless field unit and configured to wirelessly transmit power to the wireless field unit, wherein the wireless field unit is configured to receive the wirelessly transmitted power and power the field device using the wirelessly transmitted power, and wherein the wireless base unit is configured to exchange process control data with the wireless field unit.

54. The system as defined in claim 53, wherein the wireless field unit is configured to exchange process control data with a portable computing device.

55. The system as defined in claim 53, wherein the wireless field unit is configured to decrypt at least one of the wirelessly transmitted power or the process control data received from the wireless base unit.

56. The system as defined in claim 53, wherein the wireless base unit is configured to wirelessly transmit power using a spread spectrum transmission technique or a frequency hopping transmission technique.

57. The system as defined in claim 53, wherein the wireless base unit is configured to handoff the wireless field unit to another wireless base unit.

58. The system as defined in claim 53, wherein the wireless base unit is configured to continuously transmit a low-level power using a fixed frequency signal.
